(19) United States
(12) Patent Application Publication
(10) Pub. No.: US 2021/0190739 A1
(43) Pub. Date: Jun. 24, 2021

(54) ANALYZING DEVICE

(71) Applicant: SHIMADZU CORPORATION, Kyoto-shi (JP)

(72) Inventors: Yasuhiro KIMOTO, Kyoto-shi (JP); Shingo MASUDA, Kyoto-shi (JP); Koichi HAYASHI, Kyoto-shi (JP)

(73) Assignee: SHIMADZU CORPORATION, Kyoto-shi (JP)

(21) Appl. No.: 16/925,558

(22) Filed: Jul. 10, 2020

(30) Foreign Application Priority Data
Dec. 24, 2019 (JP) 2019-232541

(51) Int. Cl. G01N 30/86; G01N 30/06; G01N 30/16

(52) U.S. Cl. CPC G01N 30/8658; G01N 2030/025; G01N 30/16; G01N 30/06

(57) ABSTRACT

Provided is an analyzing device including: a storage section (21) configured to store a plurality of predetermined items concerning the state of the analyzing device and a relationship between each of the plurality of items and a parameter corresponding to the item; an item input receiver (23) configured to receive an input of one of the plurality of items; a parameter value collector (24) configured to specify a parameter corresponding to the item imputed from the item input receiver by referring to the storage section and to collect a value of the parameter from the analyzing device; and a parameter value outputter (25) configured to output the collected value of the parameter in a predetermined form. The parameter value can be outputted, for example, in the form of a two-dimensional code or a form that can be read through a short-range wireless communication. According to this technique, even unskilled operators can easily obtain values of the parameters which are necessary for understanding the state of the analyzing device.

### TECHNICAL FIELD

The present invention relates to an analyzing device, such as a chromatograph.

### BACKGROUND ART

Gas chromatographs are widely used for the testing of residual agricultural chemicals in food products as well as other purposes (for example, see Patent Literature 1). This type of test is normally performed in such a manner that a considerable number of samples are sequentially subjected to a measurement under conditions which are previously specified according to the kind of sample to be tested. A user sets test samples in an autosampler, inputs the kinds of samples, and instructs the device to initiate the measurement. Then, the samples are individually and sequentially introduced from the autosampler into the gas chromatograph and subjected to a measurement under previously set conditions. A test of this nature requires the user to merely perform routine tasks, such as the setting of the samples and the input of the kinds of samples. No expertise concerning the gas chromatograph itself is required. Therefore, it is often the case that a user who is not a skilled operator of the gas chromatograph performs the testing.

### CITATION LIST

### Patent Literature

Patent Literature 1: WO 2017/072893 A

### SUMMARY OF INVENTION

### Technical Problem

Among the problems which possibly occur during the use of a gas chromatograph, typical problems which occur due to common reasons, such as an omission of the replacement of a consumable item, can be handled by the user with the help of messages previously stored in the gas chromatograph and displayed on a screen. However, in the case of an occurrence of an irregular problem, such as a sudden halt of the measurement, it is difficult for an unskilled user to make a personal judgment and deal with the problem. Therefore, in such a case, the user contacts the support center and consults the technical staff about how to deal with the problem.

When consulting the technical staff about how to deal with the problem, the user needs to correctly understand the state of the used gas chromatograph and inform the technical staff of the state. For example, the state of the gas chromatograph relates to the configuration, setting and/or operational state of the gas chromatograph. The state of the gas chromatograph can be understood by obtaining the values of the appropriate parameters. For example, the parameter values related to the configuration of the gas chromatograph include the kinds (model numbers) of the autosampler, column oven and detector, while the parameter values related to the setting of the gas chromatograph include the values included in the measurement conditions of a sample, as well as the values related to the environmental setting, such as the presence or absence of the setting for the transition to the standby state. Examples of the parameter values related to the operational state of the gas chromatograph include the log of the occurrence of errors in each section of the device and values concerning the consumption situation of consumable items. In order to handle an irregular problem, it is necessary to determine parameters related to the problem in question and collect the values of those parameters. However, it is difficult for an unskilled operator to identify parameters from which necessary information can be obtained, and collect the values of those parameters.

The description thus far has been concerned with the handling of a problem as one example of the problem of the conventional technique. Similar problems also occur in other cases where it is necessary to identify parameters from which necessary information can be obtained, and collect the values of those parameters, as in the case of checking the validity of analysis conditions. Furthermore, although the previous description has been concerned with a gas chromatograph, the problem is not limited to gas chromatographs but can similarly occur in other types of analyzing devices.

The problem to be solved by the present invention is to provide a technique which allows even unskilled operators to easily obtain values of the parameters that are necessary for understanding the state of an analyzing device.

### Solution to Problem

An analyzing device according to the present invention developed for solving the previously described problem includes:

a storage section configured to store a plurality of predetermined items concerning the state of the analyzing device and a relationship between each of the plurality of items and a parameter corresponding to the item;

an item input receiver configured to receive an input of one of the plurality of items;

a parameter value collector configured to specify a parameter corresponding to the item imputed from the item input receiver by referring to the storage section and to collect a value of the parameter from the analyzing device; and a parameter value outputter configured to output the collected value of the parameter in a predetermined form.

An example of the “state of the analyzing device” is the configuration, setting and operational state of the analyzing device. An example of the “item” is the installation information of the analyzing device, in which case the parameters corresponding to the “item” can include, for example, the kinds and model numbers of the units constituting the analyzing device (e.g. an autosampler, column oven, detector and other units in the case of a gas chromatograph). An example of the “predetermined form” is a form that can be read with a portable device, such as a smartphone possessed by a user. More specific forms include such forms that can be scanned with a barcode reader, QR Code® reader or similar code reader, as well as a form that can be read through a short-range wireless communication.

In the analyzing device according to the present invention, when the predetermined item has been inputted by a user, a parameter corresponding to the item is identified based on the information stored in the storage section. For example, when a problem that the user cannot handle has occurred in the middle of the use of the analyzing device, the user performs an input operation for selecting installation information. Then, the model number and firmware version of each unit corresponding to the installation information are identified as parameters. With the parameters thus identified, the parameter value collector collects the values of those parameters from the analyzing device. The parameter value outputter outputs those values in a predetermined form. The analyzing device according to the present invention requires the user to merely select an item corresponding to the required information. The tasks of identifying the parameters necessary for obtaining that information and obtaining the values of those parameters are automatically performed. Even au unskilled operator can easily obtain values of the parameters which are necessary for understanding the state of the analyzing device. The parameter value outputter may be configured to simply output parameter values, or it may be configured to output parameter values with additional information. An example of such a form of information is the URL (uniform resource locator) as will be described later.

### Advantageous Effects of Invention

By the analyzing device according to the present invention, even an unskilled operator can easily obtain values of the parameters which are necessary for understanding the state of the analyzing device.

### BRIEF DESCRIPTION OF DRAWINGS

FIG. 1 is a diagram illustrating a schematic configuration of a gas chromatograph and other related systems as one embodiment of the analyzing device according to the present invention.

FIG. 2 is a diagram illustrating the configuration of a website prepared beforehand in the present embodiment.

FIG. 3 is an example of the display on a touch panel in an “Individual” mode of the present embodiment.

FIG. 4 is another example of the display on the touch panel in the “Individual” mode of the present embodiment.

FIG. 5 is still another example of the display on the touch panel in the “Individual” mode of the present embodiment.

FIG. 6 is an example of the display on a touch panel in a “Collective” mode of the present embodiment.

FIG. 7 is an example in which the parameter values outputted in the present embodiment are divided into a plurality of two-dimensional codes.

FIG. 8 is another example in which the parameter values outputted in the present embodiment are divided into a plurality of two-dimensional codes.

### DESCRIPTION OF EMBODIMENTS

An embodiment of the analyzing device according to the present invention is hereinafter described with reference to the drawings. The analyzing device according to the present embodiment is a gas chromatograph.

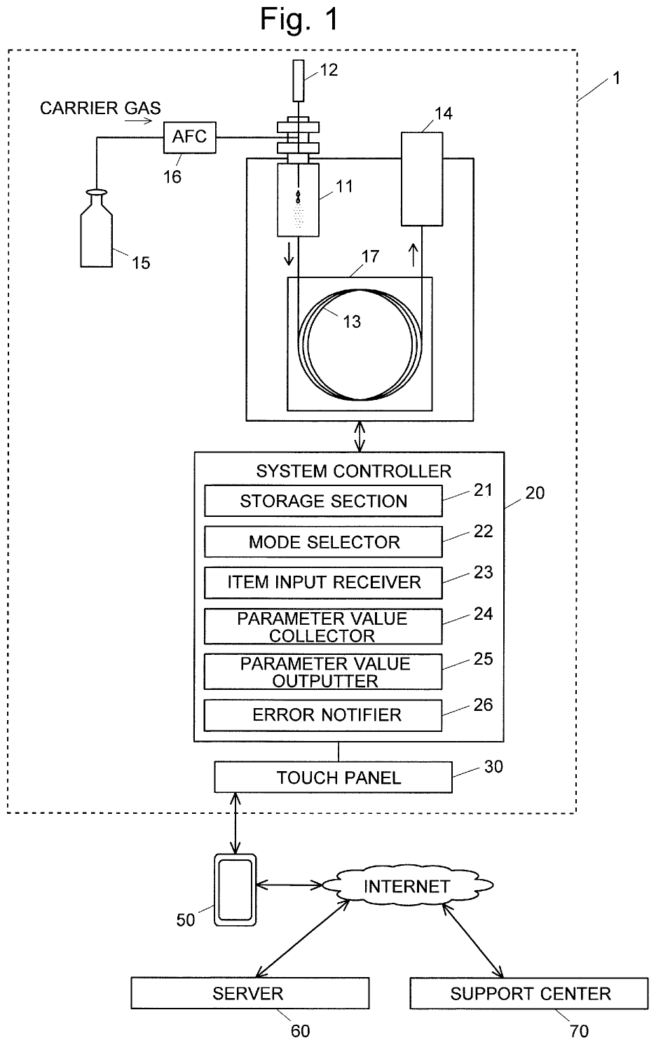

As shown in FIG. 1, the gas chromatograph 1 according to the present embodiment includes a sample vaporization chamber 11 configured to vaporize a liquid sample by heat, an injector 12 configured to inject a liquid sample into the sample vaporization chamber 11, a column 13 configured to separate sample components vaporized in the sample vaporization chamber 11, and a detector 14 configured to detect each of the components separated by the column 13. The sample vaporization chamber 11 is supplied with a flow of carrier gas, such as helium gas, contained in a cylinder 15. The flow rate of the carrier gas is regulated by a flow-rate controller (AFC) 16 and maintained at a predetermined flow rate (or flow velocity). The vaporized sample is carried by the flow of carrier gas within the sample vaporization chamber 11 and introduced into the column 13. The column 13 is contained within a column oven 17 heated to a predetermined temperature.

The sample vaporization chamber 11 and injector 12, as well as the detector 14, flow-rate controller 16, column oven 17 and other sections are each provided in the form of a unit. Those units are appropriately chosen and combined for use according to the characteristics of the sample and the purpose of the analysis. Those units are connected to a system controller 20 and operated under the control of the same controller 20. In the present embodiment, the system controller 20 is also included as one of the units constituting the gas chromatograph. The system controller 20 is connected to a workstation (not shown). The setting of detailed analysis conditions, analysis of data and other related operations are performed on the workstation. Since the operations related to the workstation are the same as before, no description concerning the workstation will be hereinafter given.

The system controller 20 has a storage section 21. The system controller 20 also includes a mode selector 22, item input receiver 23, parameter value collector 24, parameter value outputter 25, and error notifier 26 as its functional blocks. These are the functional blocks implemented by a built-in computational processor of the system controller 20. The system controller 20 is provided with a touch panel 30. This touch panel 30 functions as a display unit for displaying various kinds of information, as well as an input unit for allowing users to input various kinds of information by touching the touch panel 30. Needless to say, a configuration in which the display unit and the input unit are separately provided may be adopted in place of the touch panel 30.

The storage section 21 holds previously determined items concerning the state of the gas chromatograph 1 as well as the relationship between each item and the corresponding parameters. For example, the state of the gas chromatograph 1 includes the setting, configuration and operational state of the gas chromatograph as items corresponding to the “Individual” mode, which will be described later.

The items related to the setting of the gas chromatograph 1 include “Condition Validity” and “Eco Check”. These items have corresponding parameters, such as the analysis conditions set in the gas chromatograph 1 as well as the device environment setting of the gas chromatograph 1. The information related to the setting of the gas chromatograph 1 obtained through a process which will be described later is typically such information that changes with the setting by the user. For example, the item called “Eco Check” is related to the following parameters: “ON/OFF state of the gas-saving mode” (gassave); “period of time to make the transition to the saving mode after the completion of an analysis” (prepwait); and “setting of the period of time between analyses during a series of analyses” (idletime).

The items related to the configuration of the gas chromatograph 1 include “Instruction Manual”, “Maintenance Help” and the like. These items have corresponding parameters, such as the types and model numbers of the units constituting the gas chromatograph 1. The information obtained through a process which will be described later concerning the configuration of the gas chromatograph 1 is typically such information that depends on the characteristics of the sample and the purpose of the analysis. For example, the item called “Instruction Manual” is related to the following parameters: “model number of the main unit of the gas chromatograph 1” (gc), “type of injector” (inj1), and “type of detector unit” (det1).

The items related to the operational state of the gas chromatograph 1 include “Inquiry Form”, “Error Description” and “Degree of Consumption”. These items have corresponding parameters, such as the situation of an error which has occurred in the gas chromatograph 1, types and model numbers of the component units constituting the gas chromatograph 1, error number, error log, operation log, as well as consumable item information. For example, the item called “Inquiry Form” is related to the following parameters: “model number of the main unit of the gas chromatograph 1” (main), “type of detector unit” (det1), and “error code” (errlog).

In the storage section 21, there are two classifications, called “Device Setting” and “Operation Record”, as the classifications corresponding to the collective selection, which will be described later. The “Device Setting” classification includes items called “Installation Information”, “Environmental Setting” and “Analysis Conditions”. The “Operation Record” classification includes items called “Error Log”, “Parameter Log”, “Operation Log”, “Part Replacement Log”, “Self-Diagnosis Log” and “Analysis Log”. The contents of the parameter values corresponding to those items are as shown in Table 1. Although the present embodiment uses the term “parameter value” for convenience, it is not necessary for a parameter value to be a numerical value. Other types of data, such as text data in various logs, are also included in the parameter values. Table 1 additionally shows data size necessary for an output of the parameter values for each item.

TABLE 1

| Classification | Item | Description | Data Size |
|---|---|---|---|
| Device | Installation | Type of unit installed in the device, | 352 bytes |
| Setting | Information | ROM version of the firmware, and other | |
| | | related information. Changing this item | |
| | | of information after installation requires | |
| | | physical alteration, firmware update, or | |
| | | similar measures for which the device | |
| | | must be stopped. | |
| | Environmental | Device conditions which are not | 1,408 bytes |
| | Setting | analysis conditions yet allow for a | |
| | | change of the setting, such as the | |
| | | combination of the units in the installed | |
| | | device, or the procedure to start the | |
| | | device. | |
| | Analysis | Device conditions which are related to | 6,768 bytes |
| | Conditions | an analysis, such as introduction | |
| | | information of a sample, analysis time, | |
| | | device setting in the analysis, and status | |
| | | change of the device during the analysis. | |
| Operational | Error Log | Date and time of occurrence of an error | 2,000 bytes |
| Record | | recorded in the device, and content of | (100 records) |
| | | the error which occurred (error code) | |
| | Parameter Log | Date and time of an operation | 1,000 bytes |
| | | performed for changing a parameter, | (50 records) |
| | | and value of the changed parameter. | |
| | Operation Log | Log of an operation performed for | 1,400 bytes |
| | | activating the device for an analysis, or | (50 records) |
| | | deactivating the device. | |
| | Part Replacement | Date and time of replacement of a part, | 4,000 bytes |
| | Log | and information concerning the | (50 records) |
| | | replaced part. | |
| | Self-Diagnosis | Result of the diagnosis function which | 800 bytes |
| | Log | enables the device to recognize its | (50 records) |
| | | condition by its own function. Result of | |
| | | an examination on whether or not the | |
| | | operating time or performance of each | |
| | | unit satisfies specified criteria. | |
| | Analysis Log | Record of the date and time of an | 12,600 bytes |
| | | analysis operation, whether or not an | maximum |
| | | error occurred during the analysis, etc. | |
| | | The number of records is variable | |
| | | depending on the number of errors; e.g. | |
| | | 3,500 bytes are required for 50 analyses | |
| | | with ten errors in each analysis. | |

The classifications shown in Table 1 are merely illustrative. The names of the classifications and the items corresponding to each classification should be changed depending on the type, functions and manufacturer of the analyzing device. The file size of the operation record changes depending on the length of time over which the latest records are accumulated in the gas chromatograph 1.

Furthermore, for each of the various types of errors related to the gas chromatograph 1, the relationship between the code number corresponding to the error and the parameters related to the error is stored in the storage section 21.

The present embodiment employs a portable device 50 possessed by a user, such as a smartphone, tablet device, or notebook computer. Operations to be performed using the portable device 50 will be described later. A server 60 which is accessible from the portable device 50 of the user via the Internet is operated by the manufacturer of the gas chromatograph 1 (or other related parties). Web pages related to various types of analyzing devices including the gas chromatograph 1 are previously created on the server 60. The manufacturer of the gas chromatograph 1 (or other related parties) also has a support center 70, in which technical staff members familiar with the gas chromatograph 1 and other analyzing devices stand by.

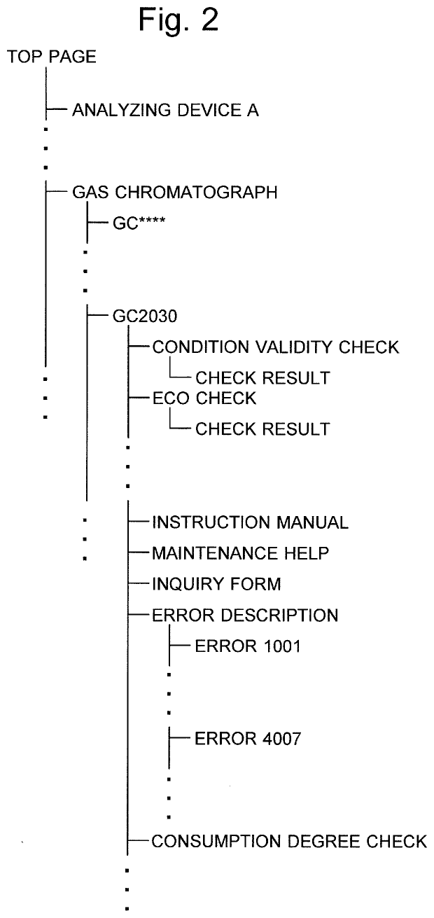

FIG. 2 shows the configuration of the web pages prepared on the server 60. The web pages include the top page, which has links to the pages corresponding to a plurality of types of analyzing devices (analyzing device A, gas chromatograph, and others).

The pages of the gas chromatograph are subdivided into specific models. One of those pages is assigned to the model number GC2030, which corresponds to the gas chromatograph 1 according to the present embodiment.

The page of model number GC2030 which corresponds to the gas chromatograph 1 according to the present embodiment has links to the “Condition Validity Check”, “Eco Check”, “Instruction Manual”, “Maintenance Help”, “Inquiry Form”, “Error Description”, “Consumption Degree Check” and other contents. The pages of Condition Validity Check, Eco Check, and Consumption Degree Check each have fields for an input of necessary parameter values. A user inputs those parameter values and performs a predetermined input operation, such as the pressing of a “Check” button, to have the check result displayed. The page of Inquiry Form also has fields for an input of necessary parameter values. The user inputs those parameter values and performs a predetermined input operation, such as the pressing of a “Submit” button, to send an inquiry to the support center 70. As for “Error Description”, a page is prepared for each error code.

An operation of the gas chromatograph 1 according to the present embodiment is hereinafter described. The flow of the measurement of a sample and other operations by the gas chromatograph 1 is basically the same as in the conventional case, and therefore, will not be described. The following description deals with the flow of the process of outputting necessary information for users, which is the characteristic operation by the gas chromatograph 1 according to the present embodiment.

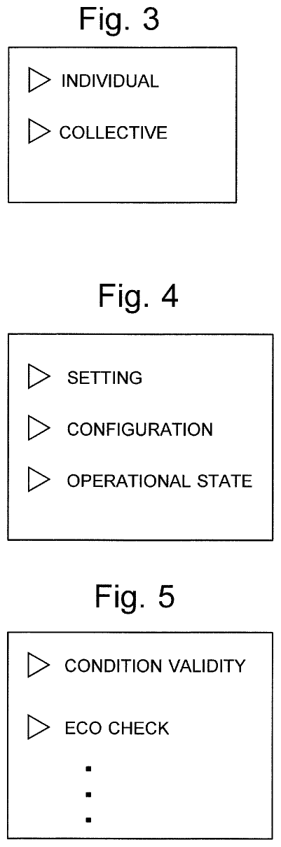

The user touches the “Menu” button displayed on the touch panel 30 of the system controller 20 in the gas chromatograph 1. Then, the mode selector 22 displays the “Individual” button and the “Collective” button as choices on the touch panel 30, as shown in FIG. 3. The “Individual” mode is used when the user should acquire a specific kind of information related to the gas chromatograph 1 or make inquiries concerning a specific error. The “Collective” mode is used, for example, when it is necessary to collectively acquire various parameter values related to the gas chromatograph 1 and send those values to the technical staff in the support center 70, as in the case of an occurrence of an error whose cause cannot be easily identified.

If the user selects the “Individual” mode (by touching the display on the touch panel 30; the same applies to the following descriptions), the item input receiver 23 displays the items named “Setting”, “Configuration” and “Operational State” on the touch panel 30, as shown in FIG. 4.

If the user selects “Setting”, the item input receiver 23 displays “Condition Validity”, “Eco Check” and other items on the touch panel 30, as shown in FIG. 5. In this situation, if the user selects “Eco Check”, the parameter value collector 24 collects the values of the parameters corresponding to “Eco Check” from the units of the gas chromatograph 1 based on the relationship stored in the storage section 21.

As described earlier, in the present embodiment, the item named “Eco Check” is related to the following parameters: ON/OFF state of the gas-saving mode (gassave); period of time to make the transition to the saving mode after the completion of an analysis (prepwait); and the setting of the period of time between analyses during a series of analyses (idletime). The parameter value collector 24 collects the parameter values of gassave=on, prepwait=3 and ideltime=6000 for the aforementioned parameters, respectively.

After the parameter values have been collected, the parameter value outputter 25 creates a URL (uniform resource locator) in which the collected parameter values are included at the specified positions, and displays the URL in the form of a two-dimensional code on the touch panel 30. This URL points to a location on the server 60 operated and managed by the manufacturer of the gas chromatograph 1 (or other related parties). For example, the URL is created in the following format:

https://www.an.xxxxx.co.jp/gc/eco/gasreport?gassave=on&prepwait=3&idletime=6000

The user scans the two-dimensional code with a predetermined application (two-dimensional code reader) previously installed on the portable device 50. The code reader decodes the URL created by the parameter value outputter 25. In response to an operation by the user, the portable device 50 accesses the page corresponding to the URL on the server 60.

The page accessed through the previously described operations corresponds to one page (one result of the Eco Check) in the web pages already described with reference to FIG. 2. The user can also directly access this page and perform the Eco Check, in which case, however, the user needs to collect parameter values from the gas chromatograph 1 by himself/herself and manually input those values.

On the other hand, in the gas chromatograph 1 according to the present embodiment, the necessary parameters are selected by the previously described series of processes, and those parameter values are automatically collected. Ultimately, a URL including those values is created. According to the present embodiment, the Eco Check can be carried out without requiring the user to select necessary parameters and collect the values of those parameters by himself/herself.

If the user selects “Configuration”, the item input receiver 23 displays “Instruction Manual”, “Maintenance Help” and other items on the touch panel 30. In this situation, if the user selects “Instruction Manual”, the parameter value collector 24 collects the values of the parameters corresponding to “Instruction Manual” from the units of the gas chromatograph 1 based on the relationship stored in the storage section 21.

As described earlier, in the present embodiment, the item “Instruction Manual” is related to the following parameters: “model number of the main unit of the gas chromatograph 1” (gc), “kind of injector” (inj1), and “kind of detector unit” (det1). The parameter value collector 24 collects the parameter values of gc=gc2030, inj1=spl and det1=fid for those parameters, respectively. The value “spl” means a split-injection type of injector unit, while “fid” means a flame ionization detector.

After the parameter values have been collected, the parameter value outputter 25 creates a URL in which the collected parameter values are included at the specified positions, and displays the URL in the form of a two-dimensional code on the touch panel 30. This URL also points to a location on the server 60 operated and managed by the manufacturer of the gas chromatograph 1 (or other related parties). For example, the URL is created in the following format:

https://www.an.xxxxx.cojp/gc/gc2030/manual?inj1=spl&det1=fid

The URL corresponds to one page among the web pages already described with reference to FIG. 2 (a page which corresponds to the previously described configuration in the instruction manual of GC2030). The user can also directly access this page from a personal computer or similar device, in which case, however, the user needs to initially visit the top page on the server 60 as well as sequentially select the type of analyzing device and the model number of the gas chromatograph. Additionally, the user needs to specify one or more units constituting the gas chromatograph 1.

On the other hand, in the gas chromatograph 1 according to the present embodiment, the necessary parameter values are automatically collected by the previously described series of processes, and a URL including those values is created. According to the present embodiment, the user can view the instruction manual corresponding to the used gas chromatograph 1, without selecting necessary parameters and collecting the values of those parameters by himself/herself.

If the user selects “Operational State”, the item input receiver 23 displays “Inquiry Form”, “Error Description”, “Degree of Consumption” and other items on the touch panel 30. In this situation, if the user selects “Inquiry Form”, the parameter value collector 24 collects the values of the parameters corresponding to “Inquiry Form” from the units of the gas chromatograph 1 based on the relationship stored in the storage section 21.

As described earlier, in the present embodiment, the item “Inquiry Form” is related to the following parameters: “model number of the main unit of the gas chromatograph 1” (main), “type of the detector unit” (det1), and “error code” (errlog). The parameter value collector 24 collects the parameter values of main=2030, det1=fid, and errlog=4007-4008 for the aforementioned parameters, respectively.

After the parameter values have been collected, the parameter value outputter 25 creates a URL in which the collected parameter values are included at the specified positions, and displays the URL in the form of a two-dimensional code on the touch panel 30. This URL points to an inquiry form on the server 60 operated and managed by the manufacturer of the gas chromatograph 1 (or other related parties). For example, the URL is created in the following format:

https://www.an.xxxxx.co.jp/gc/inquiry?main=2030&det1=fid&errlog=4007-4008

The previously described inquiry form corresponds to an inquiry form which the user can also directly access on the server 60 of the manufacturer by using a personal computer or similar device. However, in order to access this page from a personal computer or similar device, the user needs to initially visit the top page on the server 60 as well as sequentially select the type of analyzing device and the model number of the gas chromatograph. Additionally, the user himself/herself needs to investigate and input the kind of one or more units constituting the gas chromatograph 1 as well as the error code.

On the other hand, in the gas chromatograph 1 according to the present embodiment, the necessary parameter values are automatically collected by the previously described series of processes, and a URL including those values is created. According to the present embodiment, the inquiry form can be easily filled in without requiring the user to select necessary parameters and collect the values of those parameters by himself/herself.

In any of the previously described examples, the URL in which the necessary parameter values are directly included is converted into a two-dimensional code for output. The parameter values may be included in any format for output as long as the format is in accordance with a rule previously defined between the gas chromatograph 1 and the server 60. That is to say, the parameter values do not need to be human-readable character strings. For example, it may be compressed into an appropriate binary form.

The previously described example is merely illustrative. The information stored in the server 60 to be used for the checking in the previous example may be partially or entirely stored in the portable device 50 beforehand. In that case, after the two-dimensional code has been obtained by a predetermined application of the portable device 50, the information stored in the portable device 50 can be accessed to realize a function similar to the previously described one without using network connections.

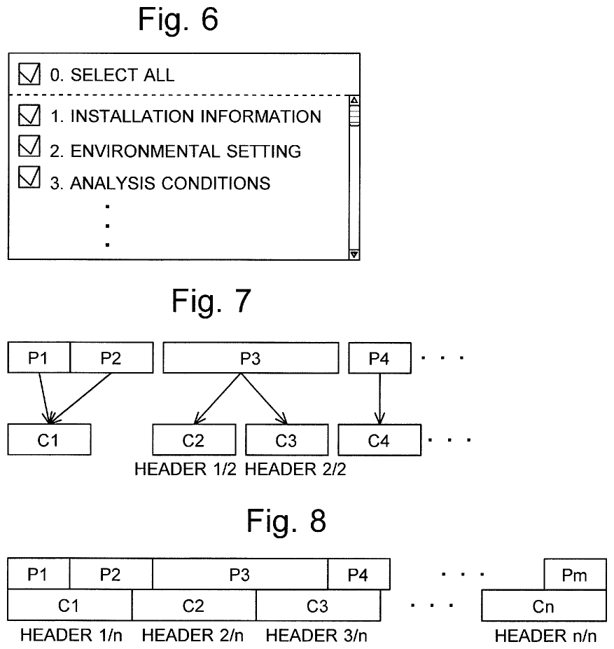

If the user selects “Collective” on the screen shown in FIG. 3, the item input receiver 23 displays the following items along with the check boxes on the touch panel 30, as shown in FIG. 6: “0. Select All”, “1. Installation Information”, “2. Environmental Setting”, “3. Analysis Conditions”, “4. Error Log”, “5. Parameter Log”, “6. Operation Log”, “7. Part Replacement Log”, “8. Self-Diagnosis Log”, and “9. Analysis Log”.

If the user checks the box of “0. Select All” and performs a selecting operation, the item input receiver 23 handles all of the 1^{st} through 9^{th} items as selected. According to this selection, the parameter value collector 24 collects the values of the parameters for each item based on the relationship stored in the storage section 21. The parameter value outputter 25 creates a two-dimensional code from the collected values and displays it on the touch panel 30.

For the “Collective” mode, the “0. Select All” option is normally used. However, for example, if the analysis conditions are confidential, an alteration to the selection may be made, such as the unchecking of the box of “3. Analysis Conditions” so as to output only the parameter values corresponding to the other items. When any one of the boxes is unchecked, the box of “0. Select All” is also automatically unchecked.

The previously described “Individual” mode is a mode designed to output the values of only a limited number of parameters which are necessary for obtaining a specific kind of information. Therefore, in many cases, those parameter values can be outputted in the form of a single two-dimensional code. On the other hand, the “Collective” mode is a mode designed to output the various parameter values (or all obtainable parameter values) related to the gas chromatograph 1, so that the data size is considerably large. Therefore, in the present embodiment, a plurality of two-dimensional codes are combined together to output those parameter values. Understandably, combining a plurality of two-dimensional codes in the “Individual” mode is also possible if there are a considerable number of parameter values to be outputted.

If “0. Select All” is selected in the example of Table 1 and all parameter values are to be outputted, the amount of data to be outputted is 8,528 bytes×2 (safety factor) 17,000 bytes for the device setting, and 12,700 bytes×2 (safety factor) 26,000 bytes for the operation record, with a total of 43,000 bytes. The safety factor has been set to take into account the difference in total data size which occurs depending on the type and function of the analyzing device as well as the variation in the kinds of parameters depending on the manufacturer. The total data size that is actually required can be appropriately determined by the provider of the analyzing device according to the type, function, and other aspects of the analyzing device.

For example, if the QR Code®, version 40, with an error correction level of “Low” is used for binary display, 2953 bytes of data can be outputted per one QR code. Accordingly, combining 15 QR codes allows for the output the previously mentioned size of data.

If the data size of the parameter values to be outputted in the form of two-dimensional codes exceeds the output capacity of a single two-dimensional code, the original data can be appropriately divided into a plurality of two-dimensional codes, with each piece of data having a header added. The header includes a piece of information which indicates that the two-dimensional codes formed by the division should form one set. For such information, various kinds of information can be appropriately combined, such as a random number, device serial number, and date. For example, values of 1/2 and 2/2 are given to the third and fourth two-dimensional codes, respectively, to indicate that these codes form one set. Adding such a piece of information merely requires 20 to 40 bytes.

FIG. 7 is one example of the combination of a plurality of two-dimensional codes. In this example, two or more parameter values which can be outputted with a single two-dimensional code are combined into one set for output. For a parameter value whose data size exceeds the output capacity of a single two-dimensional code, a plurality of two-dimensional codes are used, with each code having a header (e.g. 1/2 or 2/2), and those codes are displayed on the touch panel 30.

In the example shown in FIG. 8, the parameter values to be outputted (in FIG. 8, m parameter values) are combined into one set of data, which are sequentially assigned to a plurality of two-dimensional codes (in FIG. 8, n codes). The resulting two-dimensional codes are displayed on the touch panel 30, with each code having a header (1/n, 2/n, . . . , n/n).

As described earlier, the “Collective” mode is used, for example, when it is necessary to collectively acquire various parameter values related to the gas chromatograph 1 and send those values to the technical staff in the support center 70, as in the case of an occurrence of an error whose cause cannot be easily identified. In conventional cases, a user who wants to consult the technical staff about how to deal with an error needs to collect necessary parameter values by himself/herself. In the case of the gas chromatograph 1 according to the present embodiment, the user only needs to select “0. Select All” in the “Collective” mode to output all necessary parameter values.

Any of the previously described examples is concerned with the case of outputting various parameter values using a two-dimensional code based on an input operation (e.g. selection of an item) on the touch panel 30 by the user. Additionally, upon detecting an occurrence of an error during an operation of the gas chromatograph 1, the error notifier 26 automatically sends the item input receiver 23 the item related to the error code corresponding to the error in question, without waiting for a user operation. Then, the parameter value collector 24 performs the previously describe processing to collect parameter values corresponding to the inputted item. The parameter value outputter 25 converts the collected parameter values into one or more two-dimensional codes and displays them on the touch panel 30. Thus, the user can obtain necessary parameter values immediately after an occurrence of an error.

In recent years, the IoT (Internet of Things) has been used in such areas as home appliances. This technique can certainly be applied in analyzing devices. However, applying the IoT in an analyzing device requires the device itself to be compatible with the network. A monitoring device must also be provided to constantly monitor the state of the analyzing device through the network. Furthermore, security measures must be taken to prevent parameter values related to the analyzing device from being leaked to the outside. Thus, applying the IoT in an analyzing device considerably increases its cost. There is also no guarantee of the complete security, while related tasks are required, such as the constant updating of the security measures in the analyzing device and the monitoring device. The gas chromatograph 1 according to the present embodiment does not require those kinds of cost. Furthermore, since only the necessary parameter values are outputted at a necessary timing, a sufficient level of security can be guaranteed, for example, by preventing the output of confidential parameter values.

The previous embodiment is merely illustrative and can be appropriately changed without departing from the spirit of the present invention. Although the parameter values (or information including the parameter values) in the previous embodiment are displayed in the form of a two-dimensional code which allows the user to scan it with an application (two-dimensional code reader) on a portable device, those values may be outputted in a different form. For example, an RFID tag may be placed at a predetermined position near the touch panel 30 to write information into the RFID tag, from which the user can read information with an application (RFID reader) on the portable device.

Although the previous embodiment is a gas chromatograph, a similar configuration can be suitably applied in a liquid chromatograph, which also includes various units combined together. Needless to say, a similar configuration to the previous embodiment is also applicable to analyzing devices other than chromatographs.

### [Modes]

It is understandable for a person skilled in the art that the previously described illustrative embodiments are specific examples of the following modes of the present invention.

### (Clause 1)

An analyzing device according to one mode of the present invention includes:

a storage section configured to store a plurality of predetermined items concerning the state of the analyzing device and a relationship between each of the plurality of items and a parameter corresponding to the item;

an item input receiver configured to receive an input of one of the plurality of items;

a parameter value collector configured to specify a parameter corresponding to the item imputed from the item input receiver by referring to the storage section and to collect a value of the parameter from the analyzing device; and

a parameter value outputter configured to output the collected value of the parameter in a predetermined form.

In the analyzing device described in Clause 1, when the predetermined item has been inputted by a user, a parameter corresponding to the item is identified based on the information stored in the storage section. For example, when a problem that the user cannot handle has occurred in the middle of the use of the analyzing device, the user performs an input operation for selecting installation information. Then, the model number and firmware version of each unit corresponding to the installation information are identified as parameters. With the parameters thus identified, the parameter value collector collects the values of those parameters from the analyzing device. The parameter value outputter outputs those values in a predetermined form. The analyzing device according to the present invention requires the user to merely select an item corresponding to the required information. The tasks of identifying the parameters necessary for obtaining that information and obtaining the values of those parameters are automatically performed. Even au unskilled operator can easily obtain values of the parameters which are necessary for understanding the state of the analyzing device. The parameter value outputter may be configured to simply output parameter values, or it may be configured to output parameter values with additional information. An example of such a form of information is the URL including the information of the parameter values as in the previously described embodiment.

### (Clause 2)

In the analyzing device described in Clause 1, the predetermined form may be a form of a two-dimensional code or a form that can be read through a short-range wireless communication.

The analyzing device described in Clause 2 allows users to easily obtain necessary information by executing application software commonly installed in many portable devices, such as a smartphone or notebook computer, and scanning the two-dimensional code or performing a short-range wireless communication.

### (Clause 3)

The analyzing device described in Clause 1 or 2 may further include a display unit configured to display the item, and the item input receiver may be configured to receive an input of the item based on an operation of selecting the item through the display unit.

The analyzing device described in Clause 3 allows users to easily obtain necessary information by merely selecting an item displayed on the display unit.

### (Clause 4)

In the analyzing device described in one of Clauses 1-3, the parameter value outputter may be configured to output information including the collected value of the parameter and a uniform resource locator pointing to a location on a server prepared beforehand.

By using the analyzing device described in Clause 4, users only need to select an item displayed on the display unit to directly access a page from which necessary information can be obtained among the web pages prepared beforehand on the server.

### (Clause 5)

In the analyzing device described in one of Clauses 1-4, the parameter value outputter may be configured to output a value of the parameter by a plurality of two-dimensional codes.

The analyzing device described in Clause 5 can output a greater number of parameter values by using a plurality of two-dimensional codes.

### (Clause 6)

The analyzing device described in one of Clauses 1-5 may further include an error notifier configured to notify of an occurrence of an error when an error occurs in the analyzing device, and the item input receiver may be configured to receive an input of an item related to the error, based on the occurrence of the error.

The analyzing device described in Clause 6 allows users to obtain necessary parameter values immediately after an occurrence of an error.

### (Clause 7)

The analyzing device described in one of Clauses 1-6 may be a chromatograph including a plurality of units.

A gas chromatograph or liquid chromatograph is often composed of various units combined together. The kinds of parameters vary depending on the combination of the units. The present invention can suitably be used in this type of device since it provides a means for easily obtaining such parameters.

### REFERENCE SIGNS LIST

1 . . . Gas Chromatograph
11 . . . Sample Vaporization Chamber
12 . . . Injector
13 . . . Column
14 . . . Detector
15 . . . Cylinder
16 . . . Flow-Rate Controller
17 . . . Column Oven
20 . . . System Controller
21 . . . Storage Section
22 . . . Mode Selector
23 . . . Item Input Receiver
24 . . . Parameter Value Collector
25 . . . Parameter Value Outputter
26 . . . Error Notifier
30 . . . Touch Panel
50 . . . Portable Device
60 . . . Server
70 . . . Support Center

1. An analyzing device, comprising:
a storage section configured to store a plurality of predetermined items concerning the state of the analyzing device and a relationship between each of the plurality of items and a parameter corresponding to the item;
an item input receiver configured to receive an input of one of the plurality of items;
a parameter value collector configured to specify a parameter corresponding to the item imputed from the item input receiver by referring to the storage section and to collect a value of the parameter from the analyzing device; and
a parameter value outputter configured to output the collected value of the parameter in a predetermined form.

2. The analyzing device according to claim 1, wherein the predetermined form is a form of a two-dimensional code or a form that can be read through a short-range wireless communication.

3. The analyzing device according to claim 1, further comprising:
a display unit configured to display the item,
and the item input receiver is configured to receive an input of the item based on an operation of selecting the item through the display unit.

4. The analyzing device according to claim 1, wherein the parameter value outputter is configured to output information including the collected value of the parameter and a uniform resource locator pointing to a location on a server prepared beforehand.

5. The analyzing device according to claim 1, wherein the parameter value outputter is configured to output a value of the parameter by a plurality of two-dimensional codes.

6. The analyzing device according to claim 1, further comprising:
an error notifier configured to notify of an occurrence of an error when an error occurs in the analyzing device,
and the item input receiver is configured to receive an input of an item related to the error, based on the occurrence of the error.

7. The analyzing device according to claim 1, wherein the analyzing device is a chromatograph including a plurality of units.
